(19) United States
(12) Patent Application Publication
(10) Pub. No.: US 2015/0264724 A1
(43) Pub. Date: Sep. 17, 2015

(54) METHOD AND SYSTEM OF ESTABLISHING WIRELESS COMMUNICATION CONNECTION

(71) Applicant: Alibaba Group Holding Limited, Grand Cayman (KY)

(72) Inventor: Yunjiao Yao, Hangzhou (CN)

(21) Appl. No.: 14/656,545

(22) Filed: Mar. 12, 2015

(30) Foreign Application Priority Data
Mar. 13, 2014 (CN) 201410092908.X

(51) Int. Cl. H04W 76/02; H04W 4/00; G06Q 20/32; H04W 12/06

(52) U.S. Cl. CPC H04W 76/02; H04W 12/06; H04W 4/008; G06Q 20/327

(57) ABSTRACT

A method of establishing a wireless communication connection, a communication master device, a communication slave device, a server and a system are disclosed. The method of establishing a wireless communication connection includes broadcasting a first signal by using a first communication channel of a communication master device, the first signal carrying verification information of a second communication channel of the communication master device; receiving, via the second communication channel, a communication connection request generated by a communication slave device according to the first signal; and establishing a data communication connection with the communication slave device in the second communication channel according to the communication connection request. Using the present disclosure can improve the security of a communication process.

### CROSS REFERENCE TO RELATED PATENT APPLICATION

This application claims foreign priority to Chinese Patent Application No. 201410092908.X filed on Mar. 13, 2014, entitled “Method, Communication Master Device, Communication Slave Device, Server and System of Establishing Wireless Communication Connection”, which is hereby incorporated by reference in its entirety.

### TECHNICAL FIELD

The present disclosure relates to the field of wireless communication technologies, and in particular, to methods of establishing a wireless communication connection, a communication master device, a communication slave device, a server, and a system.

### BACKGROUND

In the field of wireless communication technologies, many kinds of specific wireless communication technologies are provided to meet the needs of different scenarios. For example, multiple different wireless communication technologies may also exist in a same scenario at the same time. For example, in a scenario applicable to short-distance wireless communication, there are communication technologies such as Bluetooth, infrared data association (IrDA), wireless local area network (WI-FI or WLAN, in which 802.11 series protocols are used in most cases), Wi-Fi Direct, Ultra Wide Band, Zigbee, Near Field Communication (NFC), etc.

In existing wireless technologies applicable to short-distance communications, ensuring the security of a communication process is an important issue. A process of establishing a communication via Bluetooth is used herein as an example. In an existing method of Bluetooth wireless communication, a Bluetooth master device sends a broadcasted signal. A Bluetooth slave device may receive the signal broadcasted by the Bluetooth master device. In this process, an asymmetric encryption technology (which is also referred to as public-key cryptography), such as a conventional Rivest-Shamir-Adleman (RSA) algorithm, is generally used to achieve authentication. The asymmetric key encryption technology uses a pair of matching keys for encryption and decryption. The two keys, namely, a public key and a private key, have the following property: each key performs a unidirectional processing on data, and the function of one key is opposite to that of the other key; when one key is used for encryption, the other key is used for decryption. A file encrypted using the public key can only be decrypted using the private key, and a file encrypted using the private key can only be decrypted using the public key. The public key is made public by an owner thereof, and the private key should be kept secret. In order to send a confidential packet, a sender may use a public key of a receiver to encrypt data, and once the data is encrypted, only the receiver can decrypt the data using a private key thereof. On the other hand, a user may process data using a private key. If a sender encrypts data using a private key, a receiver can decrypt the data using a public key provided by the sender. Because only the sender knows the private key, such processed packet forms an electronic signature, i.e., a file that cannot be generated by others. Commonly seen digital certificates include public key information, from which an identity of a user who owns an associated key pair is determined.

The signal broadcasted by the Bluetooth master device includes a Media Access Control (MAC) address of the Bluetooth master device. However, in order to prevent others from maliciously masquerading as the Bluetooth master device after cracking the MAC address, the Bluetooth master device needs to encrypt the MAC address before broadcasting the signal. In addition, the signal broadcasted by the Bluetooth master device further includes a public key.

The Bluetooth master device sets up a public key and a private key as a pair. When sending the broadcasted signal, the Bluetooth master device encrypts information including the MAC address using the private key. After receiving the signal broadcasted by the Bluetooth master device, the Bluetooth slave device can directly acquire, from the signal broadcasted by the Bluetooth master device, the public key paired with the private key that is used for encryption. Further, the Bluetooth slave device can use the public key to decrypt content in the received broadcasted signal. After decryption, the Bluetooth slave device can acquire the MAC address of the Bluetooth master device, thereby performing the subsequent communication process.

Generally, in the process described above, others cannot acquire and know the private key used by the Bluetooth master device. Therefore, even if listening to the signal broadcasted by the Bluetooth master device, others cannot masquerade as the Bluetooth master device. The longer a key is, the longer a plurality of encryption blocks into which a plaintext to be encrypted is divided during encryption are, and the better an encryption effect is. However, a block length cannot exceed a length of the key. As such, the RSA encryption algorithm converts each block of plaintext into a cipher text block having a same length as the key. In the current Bluetooth protocol, a plaintext to be encrypted has a small number of bits, and a cipher text after encryption also has a limited length. For example, in Bluetooth version 4.0, a plaintext of a MAC address to be encrypted is generally six bytes in length, and even after confusing bytes of a certain length are added, the total length is not too long. The maximum total length of a broadcasted signal is thirty-one bytes, in which a cipher text after encryption is generally only sixteen bytes or fewer in length, in addition to fixed overheads such as a field header, a reserved field and a message type. Based on specifications of the asymmetric encryption technology, a public key and a private key having a same length as a cipher text which is sixteen bytes or fewer after encryption are needed to be used, i.e., the public key and the private key are also sixteen bytes or fewer in length. In addition, for a plaintext is to be encrypted that has even fewer bytes, an actual encryption effect is unreliable.

Theoretically, the public key-private key pair used can be cracked in a sufficiently long period of time. Actually, in 1999, the RSA-155 (512 bits) algorithm was cracked successfully on a Cray C916 computer with a central memory of 3.2 G, which took five months in total. In 2002, the RSA-158 algorithm was also cracked successfully. On Dec. 12, 2009, an algorithm numbered RSA-768 (768 bits, 232 digits) was also cracked successfully.

In the foregoing example of communications between Bluetooth devices, even if the longest length, which is sixteen bytes, is used, a length of a public key and a private key is only 16 bytes*8 bit/byte=128 bit. Moreover, other devices are all capable of receiving a signal broadcasted by a Bluetooth master device. With a computing device having a strong computing power, a hacker may very likely be able to crack to a used private key from a received broadcasted signal in a relatively short period of time. As such, the hacker can communicate with other Bluetooth slave devices using a disguised Bluetooth master device, thus performing fraudulent activities. Apparently, the security is relatively low in this situation.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides a method of establishing a wireless communication connection, a communication master device, a communication slave device, a server and a system so as to provide an enhanced security.

In order to solve the technical problem described above, the embodiments of the present disclosure provide a method of establishing a wireless communication connection, a communication master device, a communication slave device, a server and a system, which are implemented as follows:

A method of establishing a wireless communication connection includes:

broadcasting a first signal via a first communication channel of a communication master device, the first signal including verification information of a second communication channel of the communication master device;

receiving, via the second communication channel, a communication connection request generated by a communication slave device according to the first signal; and

establishing a data communication connection with the communication slave device on the second communication channel according to the communication connection request.

A method of establishing a wireless communication connection includes:

receiving a first signal broadcasted by a first communication channel of a communication master device, the first signal including verification information of a second communication channel of the communication master device;

analyzing the first signal and obtaining the verification information of the second communication channel of the communication master device;

sending the verification information of the second communication channel of the communication master device to a server;

receiving a link signature that is returned from the server and generated according to the verification information of the second communication channel of the communication master device; and

requesting to establish a communication connection with the second communication channel of the communication master device based on the link signature.

A method of establishing a wireless communication connection includes:

receiving a message that is sent from a communication slave device, the message comprising verification information of a second communication channel of a communication master device;

querying whether the verification information of the second communication channel of the communication master device is legitimate, and if the verification information is legitimate, acquiring a link signature of the second communication channel; and

returning the link signature to the communication slave device.

A method of establishing a wireless communication connection includes:

a communication master device broadcasting a first signal through a first communication channel, the first signal including verification information of a second communication channel of the communication master device;

a communication slave device acquiring the verification information of the second communication channel of the communication master device from the signal broadcasted by the communication master device, and sending the acquired verification information of the second communication channel of the communication master device to a server;

the server receiving the verification information of the second communication channel of the communication master device from the communication slave device, querying whether the verification information of the second communication channel of the communication master device is legitimate, and acquiring a link signature of the second communication channel if the verification information is legitimate;

the server returning the link signature to the communication slave device;

the communication slave device establishing a connection with the communication master device through the second communication channel of the communication master device using the returned link signature; and
the communication master device communicating with the communication slave device after verifying that the link signature sent from communication slave device is legitimate using the second communication channel.

A communication master device comprises:

a first communication channel, the communication master device broadcasting a first signal via the first communication channel, and the first signal including verification information of a second communication channel of the communication master device;

the second communication channel, the communication master device receiving a communication connection request that is sent from a communication slave device and generated according to the first signal via the second communication channel; and being further used in communications with the communication slave device when a verification result of a verification unit is legitimate; and

the verification unit used for verifying whether the communication connection request sent from the communication slave device is legitimate.

A communication slave device comprises:

a first receiving unit configured to receive a first signal broadcasted by a communication master device, the first signal including verification information of a second communication channel of the communication master device; and further configured to receive a link signature that is returned from a server and generated according to the verification information of the second communication channel of the communication master device;

a sending unit configured to send the verification information of the second communication channel of the communication master device that is received by the first receiving unit to the server; and

a connection establishing unit configured to establish a connection with the communication master device through the second communication channel of the communication master device using the returned link signature.

A server includes:

a second receiving unit configured to receive a message sent from a communication slave device, the message including verification information of a second communication channel of a communication master device;

a query unit configured to query whether the verification information of the second communication channel of the communication master device is legitimate;

an acquisition unit configured to acquire a link signature of the second communication channel when a query result of the query unit indicates legitimacy; and

a returning unit configured to return the link signature to the communication slave device.

As can be seen from the above technical solutions provided by the embodiments of the present disclosure, the embodiments of the present disclosure have a server to store a link signature that is needed for establishing a communication connection between a communication slave device and a communication master device. The server verifies verification information of a second communication channel of the communication master device, and the communication master device verifies the link signature sent from the communication slave device. Such a double verification mechanism can enhance the security of a communication process. Especially, in a situation when other devices need to be verified by the server, a link signature of a second communication channel of a communication master device is difficult to be obtained, and thus the communication master device is extremely difficult to be masqueraded.

### BRIEF DESCRIPTION OF THE DRAWINGS

In order to describe the technical solutions in the embodiments of the present disclosure or existing technologies more clearly, accompanying drawings that are needed for describing the embodiments or the existing technologies are briefly described hereinafter. The drawings in the following description are merely some embodiments recorded in the present disclosure. One of ordinary skill in the art can obtain other drawings based on these accompanying drawings without making any creative efforts.

FIG. 1 is a flow chart of an embodiment of a wireless communications method according to the present disclosure.

FIG. 2 is a modular diagram of an embodiment of a wireless communications system according to the present disclosure.

FIG. 3 is a modular diagram of an embodiment of a communication master device according to the present disclosure.

FIG. 4 is a modular diagram of an embodiment of a communication slave device according to the present disclosure.

FIG. 5 is a modular diagram of an embodiment of a server according to the present disclosure.

FIG. 6 is a flow chart of an embodiment of a wireless communications method according to the present disclosure.

FIG. 7 is a flow chart of an embodiment of a wireless communications method according to the present disclosure.

FIG. 8 is a flow chart of an embodiment of a wireless communications method according to the present disclosure.

FIG. 9 is a modular diagram of an embodiment of a wireless communications system according to the present disclosure.

FIG. 10 is a flow chart of an embodiment of a wireless communications method according to the present disclosure.

FIG. 11 is a structural diagram illustrating an example apparatus as described in FIGS. 2-5 and 9.

### DETAILED DESCRIPTION

The embodiments of the present disclosure provide a method of establishing a wireless communication connection, a communication master device, a communication slave device, a server and a system.

In order to enable those skilled in the art to understand the technical solutions in the present disclosure in a better manner, the technical solutions in the embodiments of the present disclosure are described in a clear and complete manner with reference to the accompanying drawings in the embodiments of the present disclosure. The described embodiments are merely a part but not all the embodiments of the present disclosure. All other embodiments that are acquired based on the embodiments in the present disclosure without making any creative efforts by one of ordinary skill in the art shall fall within the protection scope of the present disclosure.

In the existing technologies previously mentioned, a hacker may use a disguised Bluetooth master device to communicate with other Bluetooth slave devices, thereby conducting fraudulent activities. For example, a high risk exists during a transaction (such as a face-to-face payment) that is carried out between a business and a customer via network terminals. In many cases, a business may install devices used for transaction payments in their stores, and such devices generally support one or more wireless payment methods such as an acoustic wave payment, a code scanning payment, and a Bluetooth payment, etc. For example, in a case where the Bluetooth payment is supported, a device of the business is generally set up as a Bluetooth master device, and a customer uses a mobile phone thereof as a Bluetooth slave device to carry out a payment process with the Bluetooth master device of the business. As mentioned previously, the Bluetooth master device sends a Bluetooth broadcasted signal, and normal Bluetooth devices may receive the broadcasted signal of the Bluetooth master device after proper setting. The total length of the Bluetooth broadcasted signal is thirty-one bytes, a message body carried thereby is only sixteen bytes or fewer, and generally, the broadcasted signal of the Bluetooth master device does not change. Therefore, after a Bluetooth device operated by a hacker receives the broadcasted signal sent by the Bluetooth master device of the business, the hacker can easily crack the broadcasted signal sent by the Bluetooth master device using a corresponding device, thereby acquiring a private key of the Bluetooth master device. Further, the hacker can easily masquerade as the Bluetooth master device using the MAC address, private key and public key of the Bluetooth master device. By using the disguised Bluetooth master device to conduct a transaction with the customer, the hacker can carry out illegal activities such as a fraudulent activity, which incurs damages to the interests of the business and the customer.

The present disclosure provides a wireless communications apparatus. The apparatus may set up at least two wireless communication channels. The apparatus may be an apparatus capable of using at least one of communication methods such as a Bluetooth communication method, an IrDA communication method, WIFI, WIFI Direct, Ultra Wide Band, Zigbee, and NFC, etc. This apparatus may replace a Bluetooth master device of a business.

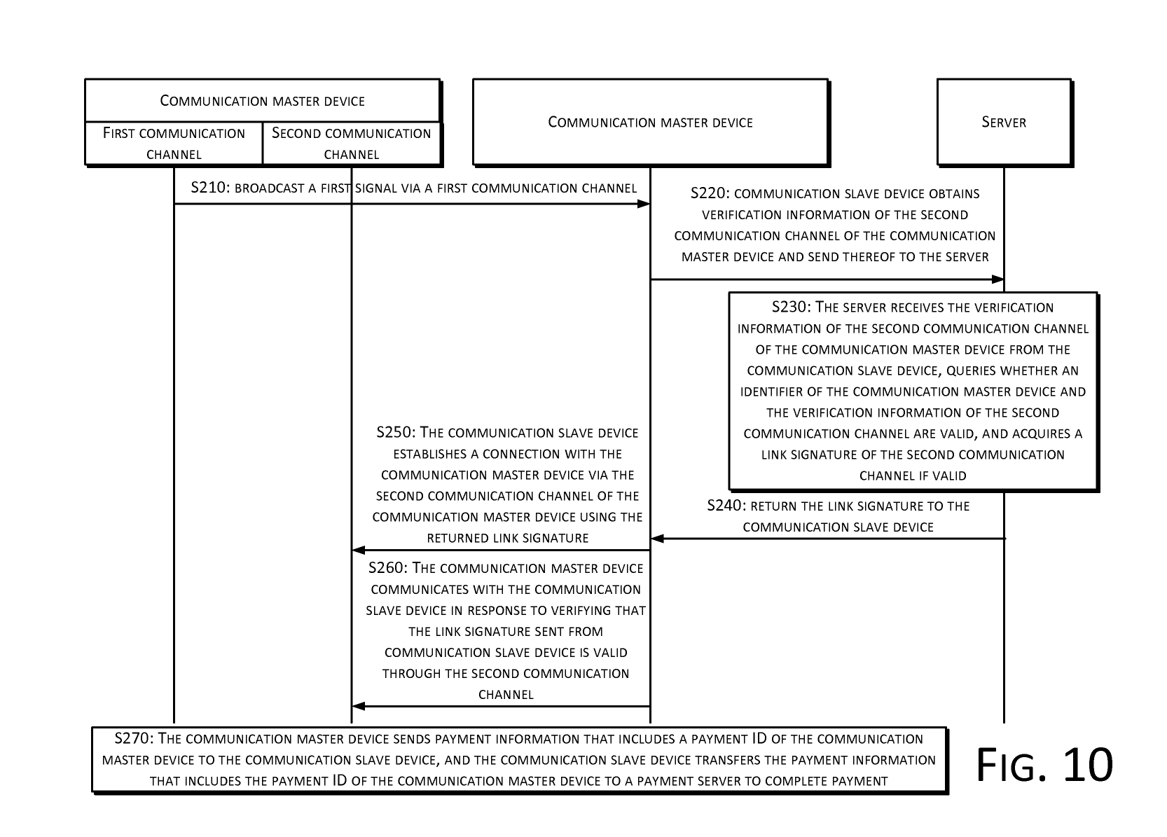

The present disclosure provides a wireless communications method, which includes method blocks as shown in FIG. 10:

S210: A communication master device broadcasts a first signal through a first communication channel, the first signal carrying verification information of a second communication channel of the communication master device.

The communication master device may broadcast the first signal through the first communication channel. The first communication channel of the communication master device may send an encrypted signal by means of broadcasting. An encryption method such as RSA or another asymmetric encryption method may be used as an encryption method for the encrypted signed.

The first signal broadcasted by the communication master device may include the verification information of the second communication channel of the communication master device. The verification information of the second communication channel is used for identification and subsequent verification of the second communication channel. A MAC address of the second communication channel may be used as the verification information of the second communication channel, or as a part of the verification information of the second communication channel.

The first communication channel of the communication master device may perform broadcasting within a specific frequency band. In order to identify a broadcasted signal, a specific wireless signal may be added to the broadcasted signal. For example, four fixed level values having a fixed byte length, e.g., all low levels or all high levels, are used in a signal broadcasted by the first communication channel to identify the signal.

S220: A communication slave device acquires the verification information of the second communication channel of the communication master device from the signal broadcasted by the communication master device, and sends the acquired verification information of the second communication channel of the communication master device to a server.

The communication slave device may be a device waiting for communications with the communication master device. The communication slave device may monitor broadcasted signals sent by the communication master device.

After receiving the signal broadcasted by the communication master device, the communication slave device may acquire the verification information of the second communication channel of the communication master device from the received broadcasted signal. The verification information of the second communication channel of the communication master device that is included in the signal broadcasted by the communication master device may be broadcasted after being encrypted. Moreover, the signal broadcasted by the communication master device may further include a public key corresponding to a private key that is used for encryption. As such, after receiving the broadcasted signal, the communication slave device may decrypt the encrypted signal using the public key in the signal to acquire corresponding information.

Thereafter, the communication slave device may send the acquired verification information of the second communication channel of the communication master device to a server. The communication slave device may acquire a communication address of the server using an application installed therein. Moreover, this application may arrange the communication slave device to perform the method block S220.

S230: The server receives the verification information of the second communication channel of the communication master device from the communication slave device, queries to determine whether the verification information of the second communication channel of the communication master device is valid, and acquires a link signature of the second communication channel if the verification information is valid.

Generally, the server records verification information of a second communication channel of each communication master device, and records a correspondence relationship therebetween. Verification information of a second communication channel of a communication master device may be unique, so that the second communication channels of the communication master devices may be differentiated from one another.

Physically, the first communication channel and the second communication channel of the communication master device may be two communications apparatuses disposed together, for example, two Bluetooth chips disposed together. This communication master device may be integrally issued/sold by an issuer/seller.

The server receives the verification information of the second communication channel of the communication master device sent from the communication slave device, and may perform verification therefor. If the verification information of the second communication channel of the communication master device sent from the communication slave device and received by the server is the same as recorded verification information of the second communication channel of the communication master device, the verification may be successful. By checking the validity of the correspondence relationship, the server may avoid masquerading of the first communication channel of the communication master device.

The server may store a link signature of the second communication channel of the communication master device. The link signature may serve as a basis for accessing the second communication channel, for example. In an embodiment, the link signature of the second communication channel of the communication master device may additionally or alternatively be stored on another entity or logical entity, so that the server can acquire the link signature of the second communication channel of the communication master device by accessing the entity or logical entity.

S240: The server returns the link signature to the communication slave device.

At S240, after successful verification, the server may return the link signature to the communication slave device. The server stores the link signature corresponding to the second communication channel of the communication master device. The link signature may serve as a basis for the communication slave device to access the second communication channel of the communication master device. In this method block, the server may send the stored link signature corresponding to the second communication channel of the communication master device to the communication slave device.

Here, the server may return the link signature to the communication slave device through a data network such as a 3G/4G data network.

S250: The communication slave device establishes a connection with the communication master device through the second communication channel of the communication master device using the returned link signature.

As mentioned above, the link signature may serve as a basis for performing communication with the second communication channel of the communication master device. After the communication slave device receives the link signature returned from the server, the communication slave device may use the returned link signature to initiate a connection request to the communication master device, for example, including the link signature in the connection request when creating the connection request.

S260: The communication master device communicates with the communication slave device upon successful verification of the legitimacy of the link signature sent by communication slave device using the second communication channel.

The communication master device may receive the request for establishing the connection from the communication slave device through the second communication channel. Further, the communication master device may verify the link signature included in the connection establishing request sent from the communication slave device. In response to verifying that the link signature is legitimate, the communication master device may consider that the communication request sent from the communication slave device may be trustable. In this way, the communication master device may perform communications with the communication slave device.

In the foregoing method embodiment, the server acquires a link signature needed for establishing a communication connection between a communication slave device and a communication master device. The server verifies verification information of a second communication channel of the communication master device, and the communication master device verifies the link signature sent from the communication slave device. Such a double verification mechanism can enhance the security of a communication process. Especially, in a situation where other devices need to be verified by the server, a link signature of a second communication channel of a communication master device is difficult to be obtained, and thus the communication master device is extremely difficult to be masqueraded.

In solutions related to a wireless payment, the communication slave device may be a mobile terminal such as a mobile phone, and the communication master device may be an electronic store. The electronic store is a communications apparatus that a seller may dispose in a store thereof, for example, a terminal device having a Bluetooth communication format. The device may be bounded to a Taobao store account or an Alipay account thereof, for example. When entering the store, a buyer may establish a communication connection with the electronic store using an application of a mobile phone thereof through a process of the foregoing method embodiment of the present disclosure. If deciding to buy a commodity in the store, the buyer may directly create an order in the store via a wireless connection method such as Bluetooth. The electronic store may send transaction information such as an order number, an order type, an order quantity, and IDs of both transaction parties to the mobile phone of the buyer through a wireless connection that is established by this embodiment of the present disclosure, for example. After that, the application in the mobile phone can transmit the order to a payment server through the Internet to further complete the order. Therefore, what the process of S210-S260 actually completes is a process of establishing a communication connection, and may further include the following after S260 in the solutions related to the wireless payment:

S270: The communication master device sends payment information that includes a payment ID of the communication master device to the communication slave device, and the communication slave device transfers the payment information that includes the payment ID of the communication master device to a payment server to complete payment.

In order to enhance the security of the communication process described above, the first communication channel of the communication master device may be set to a discoverable mode, in which pairing and connection are forbidden. For example, in a system made up of a communication master device and a communication slave device that use the Bluetooth communications protocol, a first communication channel of the communication master device may be set to a Bluetooth discoverable mode. Under the circumstance of knowing the existence of the first communication channel of the Bluetooth master device only, no more than verification information of a second communication channel of the communication master device may be known. Therefore, other Bluetooth devices can hardly masquerade as the Bluetooth master device without going through verification by the server.

In order to enhance the security of the communication process described above, a second communication channel of a communication master device may be set to a passive mode, which does not broadcast information. In this way, other communications devices cannot know the existence of the second communication channel of the Bluetooth master device without using the second communication channel of the Bluetooth master device. For example, in a system made up of a communication master device and a communication slave device that use the Bluetooth communications protocol, a second communication channel of the communication master device may be set to a Bluetooth passive mode. Other Bluetooth devices can hardly masquerade as the Bluetooth master device without knowing the existence of the second communication channel of the Bluetooth master device.

As mentioned at S210, the broadcasted first signal may be encrypted, that is, the signal including the verification information of the second communication channel of the communication master device is encrypted. In addition, in order to improve the security level of the communication process, the communication master device and the server maintain a same key. The key may be added to the encrypted information at S210. The key may be encrypted with the verification information of the second communication channel of the communication master device using, for example, an asymmetric encryption method. In this case, even if others acquire the broadcasted signal sent by the communication master device and crack the asymmetric encryption, the verification information of the second communication channel of the communication master device cannot be obtained because of the lack of the legitimate key, thus improving the security of the communication process.

As mentioned at S210, the encrypted information may include the verification information of the second communication channel of the communication master device. In addition, in order to improve the security level of the communication process, a dynamic random number may be added to the encrypted information at S210. This dynamic random number may be acquired by the communication master device and the server based on a same algorithm and a same criterion, for example, based on a same time reference such as a current time. When clocks of the Bluetooth master device and the server are in a synchronous state, an accuracy up to a second may be achieved based on the current time. In an embodiment, according to a condition of synchronization and a security requirement, different levels of accuracy such as a minute or an hour may be selected. In this manner, under the circumstance that the communication master device and the server have clocks that are substantially consistent with each other, the server may verify the dynamic random number according to the same algorithm and on the basis of the implementation of the asymmetric encryption and decryption, so as to verify whether the verification information of the second communication channel of the communication master device is valid. In this way, even if others acquire the broadcasted signal sent by the communication master device and crack the asymmetric encryption, the verification information of the second communication channel of the communication master device cannot be obtained because of the lack of knowledge of the algorithm that generates the dynamic random number, thus enhancing the security of the communication process.

In an embodiment, for better security, in addition to the verification information of the second communication channel of the communication master device, the encrypted information at S210 may further include the dynamic random number and a key for symmetric encryption.

In the foregoing method embodiment, a Bluetooth wireless communication connection is suitable for use between the communication master device and the communication slave device. In a situation when a Bluetooth wireless communication connection is used, more buyers are supported and transactions are completed more quickly and flexibly while ensuring the high security in a wireless payment scenario because the Bluetooth technology does not need a directional connection between the Bluetooth master device and the Bluetooth slave device, and the Bluetooth technology supports a certain number of concurrent connections and needs a short connection time for communications. In addition, by supporting a multi-user concurrent mode, users do not need to wait in a checkout line or stay at a certain place, but only need to be located within a signal range of the Bluetooth device.

Similarly, such wireless connection technology as the WiFi Direct can also support simultaneous connection of multiple devices. Moreover, a WiFi Direct device may achieve a direct connection with a conventional WiFi device that does not support this standard, and supports 2.4 GHz or 5 GHz frequency to achieve a transmission speed and coverage of the conventional WiFi (with 802.11n being the highest standard). Based on the above embodiment provided by the present disclosure, it is easy to know that the WiFi Direct wireless connection technology is also applicable to the present disclosure.

Similarly, communications technologies such as IrDA, Ultra Wide Band, Zigbee, and NFC are also applicable to the present disclosure, and are not redundantly described herein.

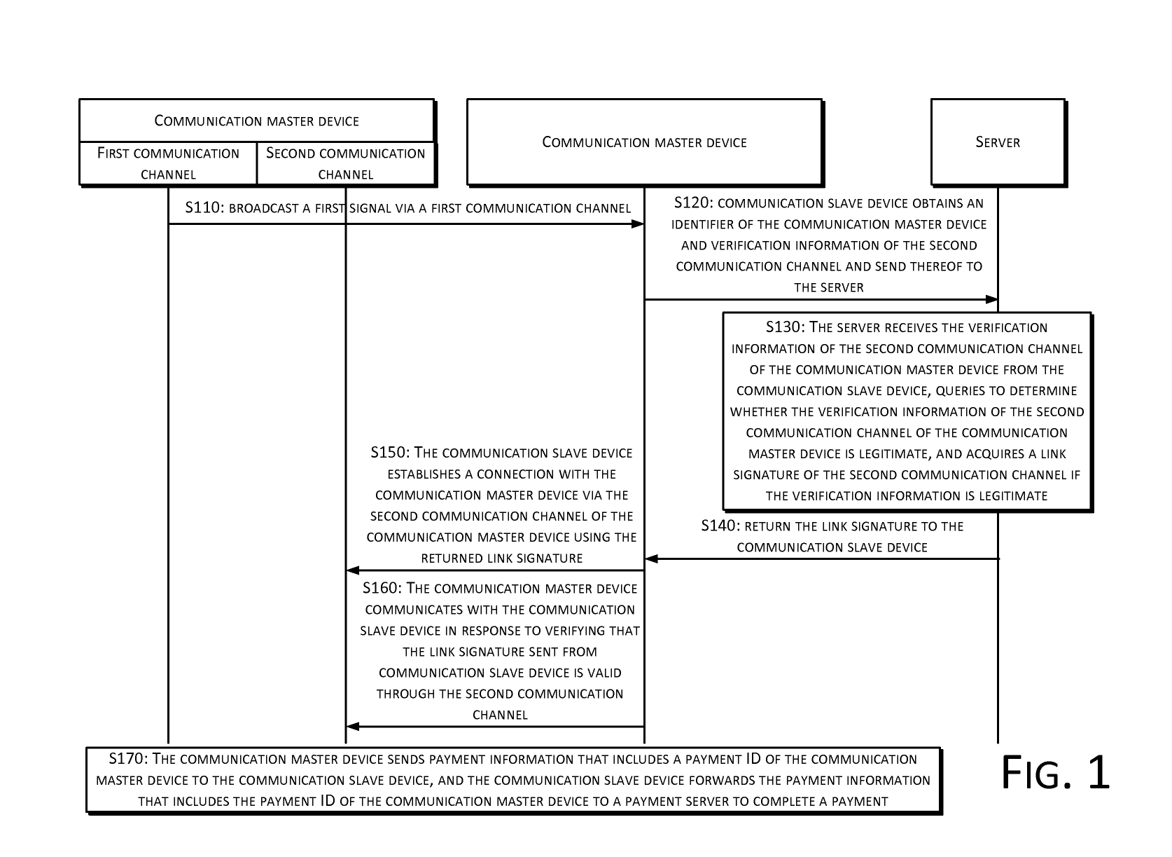

The present disclosure provides another wireless communications method, which includes method blocks as shown in FIG. 1:

S110: A communication master device broadcasts a first signal through a first communication channel, the first signal carrying an identifier of the communication master device and verification information of a second communication channel.

The communication master device may broadcast the first signal through the first communication channel. The first communication channel of the communication master device may send an encrypted signal in a broadcasting manner. The encrypted signal may be encrypted using, for example, RSA or another asymmetric encryption method.

The first signal broadcasted by the communication master device may include the identifier of the communication master device and the verification information of the second communication channel. The identifier of the communication master device is used to uniquely identify the communication master device, so as to distinguish the communication master device from other communications devices. For example, an identifier of the first communication channel may serve as the identifier of the communication master device. In practice, a communications device having a network communication capability is usually assigned with a globally unique identifier—MAC (Media Access Control) address after manufacture. Such MAC address can be used for uniquely identifying the communications device. For example, the MAC address of the first communication channel may serve as the device identifier of the communication master device herein, or serve as a part of the identifier of the communication master device.

The verification information of the second communication channel is used for identifying and subsequent verifying the second communication channel. Similarly, a MAC address of the second communication channel may be served as the verification information of the second communication channel, or served as a part of the verification information of the second communication channel.

The first communication channel of the communication master device may broadcast the first signal within a specific frequency band. In order to identify the broadcasted signal, a specific wireless signal may be added to the broadcasted signal for identification. For example, in a signal broadcasted by the first communication channel, four fixed level values having a fixed byte length, e.g., all low levels or all high levels, are used to identify the signal.

S120: The communication slave device acquires the identifier of the communication master device and the verification information of the second communication channel from the signal broadcasted by the communication master device, and sends the acquired identifier of the communication master device and the acquired verification information of the second communication channel to a server.

The communication slave device may be a device waiting to communicate with the communication master device. The communication slave device may listen to the broadcasted signal sent by the communication master device.

After receiving the signal broadcasted by the communication master device, the communication slave device may acquire the identifier of the communication master device and the verification information of the second communication channel from the received broadcasted signal. The identifier of the communication master device and the verification information of the second communication channel included in the signal broadcasted by the communication master device may be broadcasted after being encrypted. Moreover, the signal broadcasted by the communication master device may further include a public key corresponding to a private key that is used for encryption. In this manner, after receiving the broadcasted signal, the communication slave device may decrypt the encrypted signal using the public key therein to acquire corresponding information.

Thereafter, the communication slave device may send the acquired identifier of the communication master device and the acquired verification information of the second communication channel to the server. The communication slave device may acquire a communication address of the server via an application installed thereon. Moreover, such application may arrange the communication slave device to perform the method block S120.

S130: The server receives the identifier of the communication master device and the verification information of the second communication channel from the communication slave device, queries whether the identifier of the communication master device and the verification information of the second communication channel are valid, and acquires a link signature of the second communication channel if valid.

Generally, the server records an identifier of each communication master device and verification information of a second communication channel of each communication master device, and records a correspondence relationship therebetween. Identifiers of communication master devices are unique, so that the communication master devices may be differentiated from one another. As described above, an identifier of a communication master device may be an identifier of a first communication channel of the communication master device, for example, a MAC address of the first communication channel. Similarly, verification information of second communication channels of the communication master devices may also be unique, so that the second communication channels of the communication master devices may be differentiated from one another.

Physically, the first communication channel and the second communication channel of the communication master device may be two communications apparatuses disposed together, for example, two Bluetooth chips disposed together. This type of communication master device may be integrally issued/sold by an issuer/seller.

It can be understand that, the correspondence relationship between the identifier of each communication master device and the verification information of the second communication channel is also unique.

The server receives the identifier of the communication master device and the verification information of the second communication channel that are sent from the communication slave device, and may perform verification thereof. If the identifier of the communication master device and the verification information of the second communication channel that are sent by the communication slave device and received by the server are the same as and have the same correspondence relationship as the recorded identifier of the communication master device and verification information of the second communication channel, the verification is passed. The server checks the validity of the correspondence relationship, thus avoiding masquerading of the first communication channel or the second communication channel of the communication master device.

The server may store a link signature of the second communication channel of the communication master device. The link signature may be served as, for example, a basis for access to the second communication channel. In an embodiment, the link signature of the second communication channel of the communication master device may additionally or alternatively be stored on another entity or logical entity, so that the server may acquire the link signature of the second communication channel of the communication master device by accessing the entity or logical entity.

S140: The server returns the link signature to the communication slave device.

At S140, after successful verification, the server may return the link signature to the communication slave device. The server stores the link signature corresponding to the second communication channel of the communication master device, and the link signature may be served as a basis used by the communication slave device to access the second communication channel of the communication master device. At this method block, the server may send the stored link signature corresponding to the second communication channel of the communication master device to the communication slave device.

Here, the server may return the link signature to the communication slave device via a data network such as a 3G/4G data network.

S150: The communication slave device establishes a connection with the communication master device via the second communication channel of the communication master device using the returned link signature.

As mentioned above, the link signature may be served as a basis for communications with the second communication channel of the communication master device. After the communication slave device receives the link signature returned from the server, the communication slave device may use the returned link signature to initiate a connection request to the communication master device. For example, the link signature may be included in the connection request when being created.

S160: The communication master device communicates with the communication slave device in response to verifying that the link signature sent from communication slave device is valid through the second communication channel.

The communication master device may receive the connection establishing request sent by the communication slave device through the second communication channel. Further, the communication master device may verify the link signature included in the connection establishing request that is sent from the communication slave device. Upon verifying that the link signature is valid, the communication master device may consider that the communication request sent by the communication slave device is credible. In this way, the communication master device may perform communications with the communication slave device.

In the method embodiment described above, the server acquires a link signature needed for establishing a communication connection between a communication slave device and a communication master device. The server verifies an identifier of the communication master device and verification information of a second communication channel of the communication master device, and the communication master device verifies the link signature sent by the communication slave device—such a double verification mechanism can enhance the security of a communication process. Especially, in a case where other devices need to be verified by the server, acquisition of a link signature of a second communication channel of a communication master device is difficult, thus leading to a high difficulty in masquerading as the communication master device.

In solutions related to a wireless payment, the communication slave device may be a mobile terminal such as a mobile phone, and the communication master device may be an electronic store. The electronic store is a communications device that a seller may dispose in a store thereof, for example, a terminal device having a Bluetooth communication format. The device, for example, may be bounded to a Taobao store account or an Alipay account thereof. When a buyer enters the store, the buyer may establish a communication connection with the electronic store using a mobile phone thereof and through a process of the method embodiment of the present disclosure described above. If the buyer decides to buy a commodity in the store, the buyer may directly create an order in the store via a wireless connection method such as Bluetooth. For example, the electronic store may send transaction information such as an order number, an order type, an order quantity and IDs of both transaction parties to the mobile phone of the buyer via a wireless connection established using the embodiment of the present disclosure. Thereafter, an application in the mobile phone may transmit the order to a payment server through the Internet, thereby further completing the order. Therefore, what the process of S110-S160 actually completes is a process of establishing a communication connection. In the solutions related to the wireless payment, the method may further include, after S160, the following:

S170: The communication master device sends payment information that includes a payment ID of the communication master device to the communication slave device, and the communication slave device forwards the payment information that includes the payment ID of the communication master device to a payment server to complete a payment.

In order to enhance the security of the foregoing communication process, the first communication channel of the communication master device may be set in a discoverable mode, in which pairing and connection are forbidden. For example, in a system made up of a communication master device and a communication slave device that use the Bluetooth communications protocol, a first communication channel of the communication master device may be set in a Bluetooth discoverable mode. Under the circumstance that only the existence of the first communication channel of the Bluetooth master device is known, other Bluetooth devices may at best learn an identifier of the communication master device and verification information of a second communication channel, and therefore can hardly masquerade as the Bluetooth master device without going through verification conducted by the server.

In order to enhance the security of the communication process described above, the second communication channel of the communication master device may be set in a passive mode, and does not broadcast information. In this way, other communications devices cannot know the existence of the second communication channel of the Bluetooth master device without using the second communication channel of the Bluetooth master device. For example, in a system made up of a communication master device and a communication slave device that use the Bluetooth communications protocol, the second communication channel of the communication master device may be set in a Bluetooth passive mode. Other Bluetooth devices can hardly masquerade as the Bluetooth master device without knowing the existence of the second communication channel of the Bluetooth master device.

As mentioned at S110, the broadcasted first signal may be encrypted, that is, the signal including the identifier of the communication master device and the verification information of the second communication channel is encrypted. In addition, in order to improve the security level of the communication process, the communication master device and the server may maintain a same secret key. The secret key may be added to the encrypted information at S110. This key, together with the identifier of the communication master device and the verification information of the second communication channel, may be encrypted in an asymmetric encryption manner. As such, even if others acquire the broadcasted signal sent by the communication master device and crack an associated asymmetric encryption, the identifier of the communication master device and the verification information of the second communication channel cannot be obtained because of the lack of the valid secret key, thus enhancing the security of the communication process.

As mentioned at S110, the encrypted information may include the identifier of the communication master device and the verification information of the second communication channel. In addition, in order to improve the security level of the communication process, a dynamic random number may be added to the encrypted information at S110. This type of dynamic random number may be acquired by the communication master device and the server according to a same algorithm and based on a same reference. For example, the communication master device and the server acquire the dynamic random number based on a same time reference such as a current time. When clocks of the Bluetooth master device and the server are in a synchronous state, the accuracy of the random dynamic number can be obtained up to a second based on the current time. In an embodiment, based on a condition of synchronization and security need, different accuracy levels such as a minute and a hour may be selected. In this manner, when the communication master device and the server have clocks that are substantially consistent, the server may verify the dynamic random number according to the same algorithm and on the basis of implementation of the asymmetric encryption and decryption, so as to verify the validity of the identifier of the communication master device and the verification information of the second communication channel. In this way, even if others acquire the broadcasted signal sent by the communication master device and crack the asymmetric encryption, the identifier of the communication master device and the verification information of the second communication channel cannot be obtained because of the lack of knowledge of the algorithm that generates the dynamic random number, thus enhancing the security of the communication process.

In an embodiment, in order to achieve better security, in addition to the identifier of the communication master device and the verification information of the second communication channel, the encrypted information at S110 may further include a dynamic random number and a secret key for symmetric encryption.

In the foregoing method embodiment, a Bluetooth wireless communication connection is applicable for use between the communication master device and the communication slave device. When the Bluetooth wireless communication connection is used, the Bluetooth wireless communication connection can support more buyers and complete transactions more quickly and flexibly while ensuring high security in a wireless payment scenario, because the Bluetooth technology does not need a directional connection between the Bluetooth master device and the Bluetooth slave device, and the Bluetooth technology supports a certain number of concurrent connections with a connection time for communications being short. In addition, the Bluetooth technology supports a multi-user concurrent mode, so that no queuing or staying at a certain place to make a payment is needed, as long as being within a signal range of the Bluetooth device.

Similarly, a wireless connection technology such as the WiFi Direct can also support simultaneous connections of multiple devices. Moreover, a WiFi Direct device may achieve a direct connection with a conventional WiFi device that does not support this standard, support 2.4 GHz or 5 GHz frequency, and may achieve the transmission speed and coverage of the conventional WiFi (where 802.11n is the highest standard). Based on the above embodiment provided by the present disclosure, it is easy to know that the Wi-Fi Direct wireless connection technology is also applicable to the present disclosure.

Similarly, communications technologies such as the IrDA, Ultra Wide Band, Zigbee, and NFC are also applicable to the present disclosure, which are not described in detail herein.

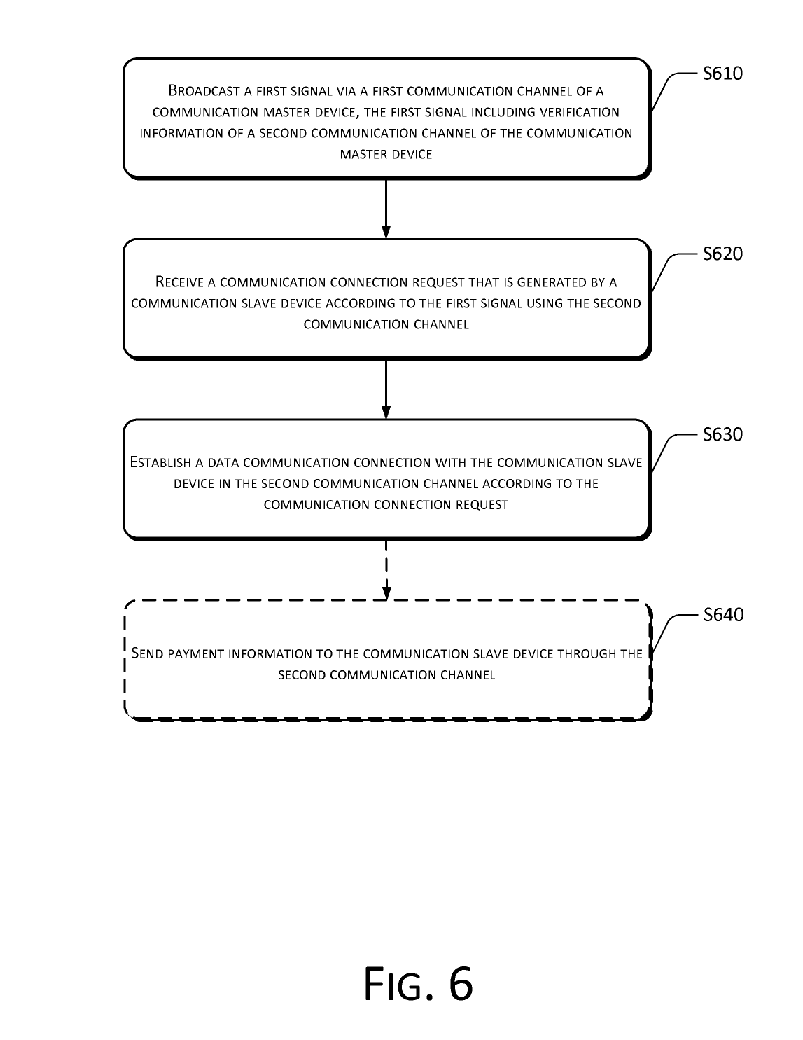

An embodiment of a method of establishing a wireless communication connection according to the present disclosure is described hereinafter. FIG. 6 shows a flow chart of this embodiment. As shown in FIG. 6, the method includes:

S610 broadcasts a first signal via a first communication channel of a communication master device, the first signal including verification information of a second communication channel of the communication master device.

The verification information of the second communication channel of the communication master device may include a MAC address of the second communication channel.

In addition, the first signal may further include an identifier of the communication master device. Correspondingly, a communication connection request may include a link signature that is generated according to the identifier of the communication master device and the verification information of the second communication channel. As described above, the identifier of the communication master device may include an identifier of the first communication channel of the communication master device. The identifier of the first communication channel of the communication master device may include a MAC address of the first communication channel.

S620 receives a communication connection request that is generated by a communication slave device according to the first signal using the second communication channel.

The communication connection request generated according to the first signal may be a communication connection request generated based on the verification information of the second communication channel of the communication master device included in the first signal, or may be a link signature generated based on the identifier of the communication master device and the verification information of the second communication channel device included in the first signal.

S630 establishes a data communication connection with the communication slave device in the second communication channel according to the communication connection request.

As described above, the first communication channel of the communication master device may be set to a single operation mode, and the single operation mode may be a discoverable mode, for example. Similarly, the second communication channel of the communication master device may be set to a single operation mode, and the single operation mode may be a passive connection mode, for example.

As described above, in the solutions related to the wireless payment, the method may further include, after S630, the following:

S640: The communication master device sends payment information to the communication slave device through the second communication channel.

A wireless connection method used between the communication master device and the communication slave device may include at least one of the following: Bluetooth, IrDA, Ultra Wide Band, Zigbee and NFC.

An entity for performing the above method embodiment may be a communication master device.

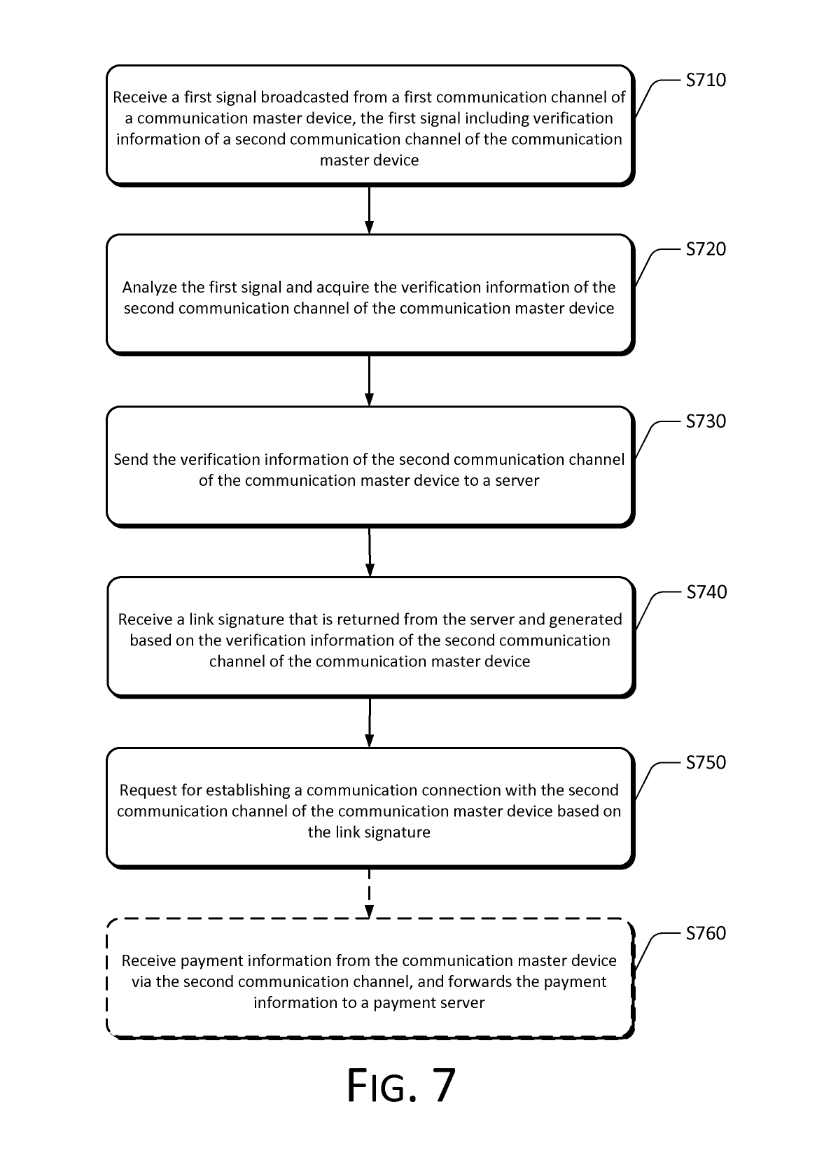

An embodiment of a method of establishing a wireless communication connection according to the present disclosure is described hereinafter. FIG. 7 shows a flow chart of this embodiment. As shown in FIG. 7, the method includes:

S710 receives a first signal broadcasted from a first communication channel of a communication master device, the first signal including verification information of a second communication channel of the communication master device.

The verification information of the second communication channel of the communication master device may include a MAC address of the second communication channel.

In addition, the first signal may further include an identifier of the communication master device. As described above, the identifier information of the communication master device may include an identifier of the first communication channel of the communication master device. The identifier of the first communication channel of the communication master device may include a MAC address of the first communication channel of the communication master device.

S720 analyzes the first signal and acquires the verification information of the second communication channel of the communication master device.

If the first signal at S710 further includes the identifier of the communication master device, the identifier of the communication master device and the verification information of the second communication channel may be acquired by analyzing the first signal at S720 herein correspondingly.

S730 sends the verification information of the second communication channel of the communication master device to a server.

If the identifier of the communication master device and the verification information of the second communication channel are acquired after analyzing the first signal at S720, the identifier of the communication master device and the verification information of the second communication channel may be sent to the server at S730.

S740 receives a link signature that is returned from the server and generated based on the verification information of the second communication channel of the communication master device.

If the identifier of the communication master device and the verification information of the second communication channel are sent to the server at S730, the link signature may be a link signature that is generated based on the identifier of the communication master device and the verification information of the second communication channel at S740.

S750 requests for establishing a communication connection with the second communication channel of the communication master device based on the link signature.

As described above, in the solutions related to the wireless payment, after S750, the method may further include:

S760 receives payment information from the communication master device via the second communication channel, and forwards the payment information to a payment server.

A wireless connection method used between the communication master device and the communication slave device may include at least one of the following: Bluetooth, IrDA, Ultra Wide Band, Zigbee and NFC.

An entity for performing the above method embodiment may be a communication slave device.

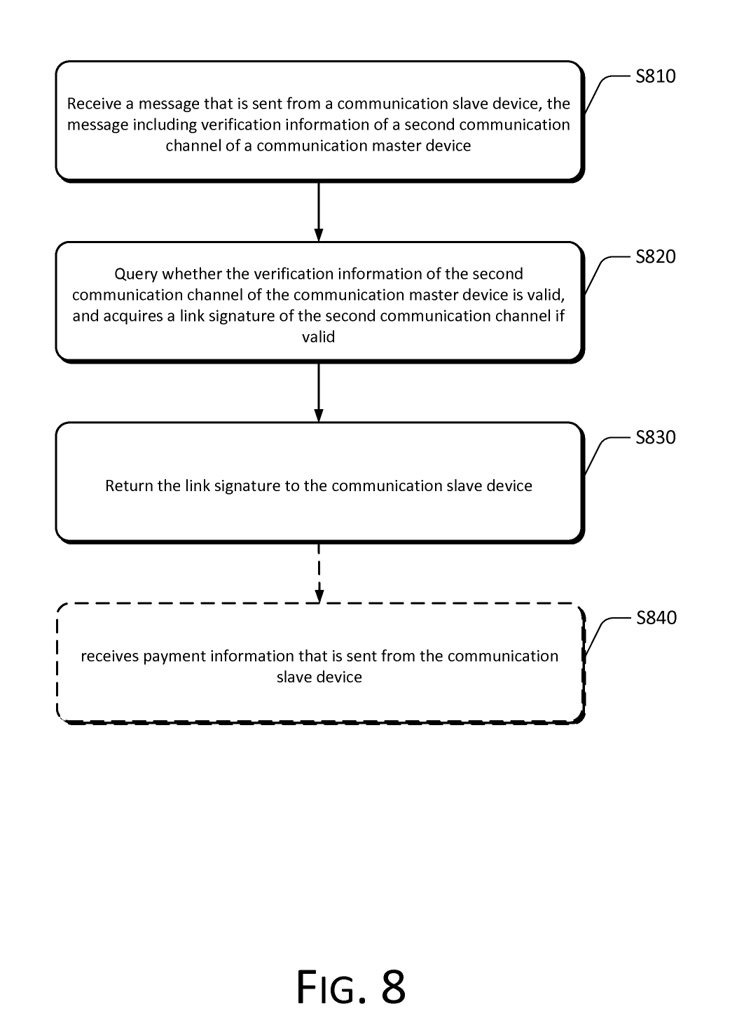

An embodiment of a method of establishing a wireless communication connection according to the present disclosure is described hereinafter. FIG. 8 shows a flow chart of this embodiment. As shown in FIG. 8, the method includes:

S810 receives a message that is sent from a communication slave device, the message including verification information of a second communication channel of a communication master device.

The verification information of the second communication channel of the communication master device may include a MAC address of the second communication channel.

In addition, the message that is sent from the communication slave device may further include an identifier of the communication master device. As described in the foregoing, the identifier information of the communication master device may include an identifier of a first communication channel of the communication master device. The identifier of the first communication channel of the communication master device may include a MAC address of the first communication channel of the communication master device.

S820 queries to determine whether the verification information of the second communication channel of the communication master device is valid, and acquires a link signature of the second communication channel if valid.

If the message that is sent from the communication slave device at S810 further includes the identifier of the communication master device, a query may correspondingly be made as to whether the identifier of the communication master device and the verification information of the second communication channel are valid at S820.

As described above, the server may store a link signature of the second communication channel of the communication master device. The link signature may be served as, for example, a basis for access to the second communication channel. In an embodiment, the link signature of the second communication channel of the communication master device may also be stored on another entity or logical entity, so that the server can acquire the link signature of the second communication channel of the communication master device by accessing the entity or logical entity.

After receiving the verification information of the second communication channel of the communication master device from the communication slave device, the server may perform verification thereof. If the verification information of the second communication channel of the communication master device sent from the communication slave device and received by the server is the same as recorded verification information of the second communication channel of the communication master device, the verification may be passed. Through checking the validity of a correspondence relationship by the server, masquerading of the first communication channel of the communication master device may be avoided.

Alternatively, after receiving the identifier of the communication master device and the verification information of the second communication channel from the communication slave device, the server may perform verification thereof. If the identifier of the communication master device and the verification information of the second communication channel that are sent from the communication slave device and received by the server are the same as and have the same correspondence relationship as a recorded identifier of the communication master device and recorded verification information of the second communication channel, the verification may be passed. Through checking the validity of the correspondence relationship by the server, masquerading of the first communication channel or second communication channel of the communication master device may be avoided.

S830 returns the link signature to the communication slave device.

Upon successful verification, the server may return the link signature to the communication slave device. The server stores the link signature corresponding to the second communication channel of the communication master device. The link signature may be served as a basis used by the communication slave device to access the second communication channel of the communication master device. In this method block, the server may send the stored link signature corresponding to the second communication channel of the communication master device to the communication slave device.

As described above, in the solutions related to the wireless payment, after S830, the method may further include:

S840 receives payment information that is sent from the communication slave device.

An entity for performing the above method embodiment may be a server.

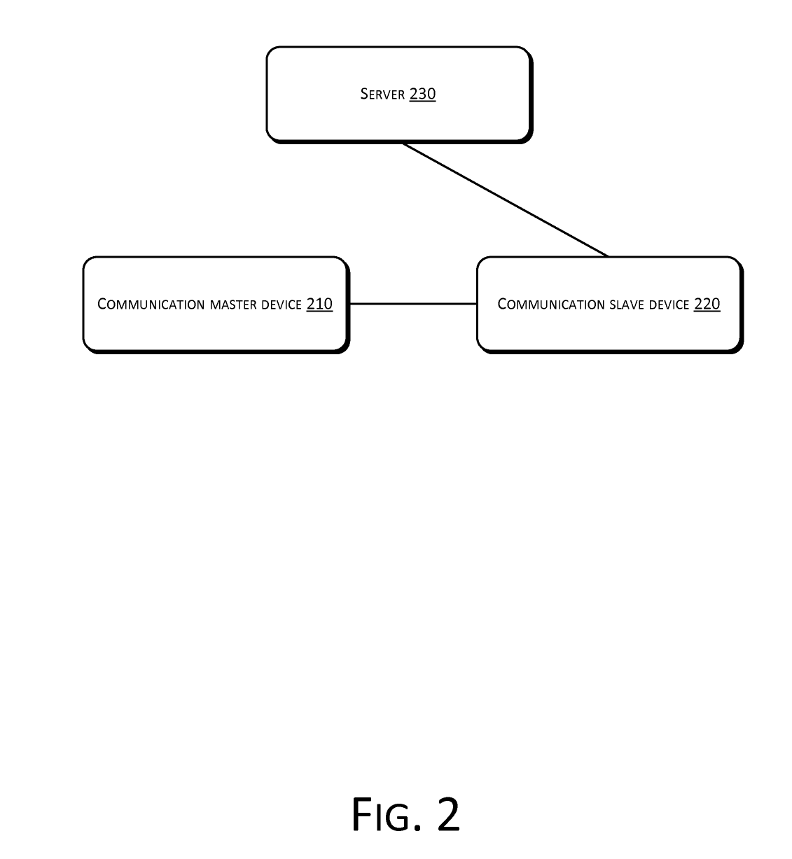

An embodiment of a wireless communications system of the present disclosure is described hereinafter. As shown in FIG. 2, the wireless communications system 200 includes:

a communication master device 210, which includes a first communication channel and a second communication channel, the communication master device 320 broadcasting a first signal through the first communication channel, and the first signal including verification information of the second communication channel of the communication master device 210; the communication master device 210 receiving a communication connection request that is generated according to the first signal from a communication slave device 220 via the second communication channel; and the communication master device 210 further configured to communicate with the communication slave device 220 when a verification result of a verification unit indicates that the verification information is valid;

the communication slave device 220, used for receiving the first signal broadcasted by the communication master device 210, the first signal including the verification information of the second communication channel of the communication master device 210; sending the verification information of the second communication channel of the communication master device 210 that is received by a first receiving unit to a server 230; and establishing a connection with the communication master device 210 through the second communication channel of the communication master device 210 using a returned link signature; and

the server 230, used for receiving a message sent from the communication slave device 220, the message including the verification information of the second communication channel of the communication master device 210; querying to determine whether the verification information of the second communication channel of the communication master device 210 is valid; acquiring the link signature of the second communication channel when a query result of a query unit indicates that the verification information is valid; and returning the link signature to the communication slave device 220.

In another embodiment of a wireless communications system of the present disclosure as shown in FIG. 2, the wireless communications system 200 may include:

a communication master device 210, which includes a first communication channel and a second communication channel, where the communication master device 210 broadcasts a first signal through the first communication channel, and the first signal includes an identifier of the communication master device 210 and verification information of the second communication channel; the communication master device 210 receiving a communication connection request that is generated according to the first signal from a communication slave device 220 via the second communication channel; and the communication master device 210 used for communicating with the communication slave device 220 when a verification result of a verification unit indicates that the identifier and the verification information are valid;

the communication slave device 220, used for receiving the first signal broadcasted from the communication master device 210, where the first signal includes the identifier of the communication master device 210 and the verification information of the second communication channel; sending the identifier of the communication master device 210 and the verification information of the second communication channel that are received by a first receiving unit to a server; and establishing a connection with the communication master device 2120 using a returned link signature through the second communication channel of the communication master 210 device; and

the server 230, used for receiving a message from the communication slave device 220, where the message includes the identifier of the communication master device 210 and the verification information of the second communication channel; querying to determine whether the identifier of the communication master device 210 and the verification information of the second communication channel are valid; acquiring the link signature of the second communication channel when a query result of a query unit indicates that the identifier and the verification information are valid; and returning the link signature to the communication slave device 220.

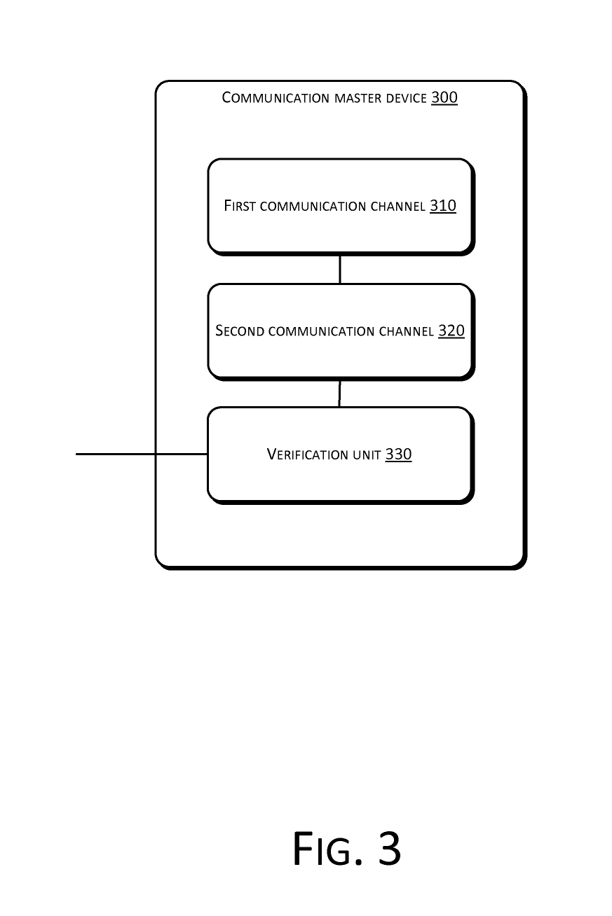

An embodiment of a communication master device of the present disclosure is described herein. As shown in FIG. 3, the communication master device 300 includes:

a first communication channel 310, wherein the communication master device 300 broadcasts a first signal through the first communication channel, and the first signal includes verification information of a second communication channel of the communication master device 300;

the second communication channel 320, wherein the communication master device 300 receives a communication connection request that is sent from a communication slave device and generated according to the first signal through the second communication channel; and the second communication channel further used for communicating with the communication slave device when a verification result of a verification unit 330 indicates that the communication connection request is valid; and

the verification unit 330, used for verifying whether the communication connection request sent from the communication slave device is valid.

The first signal may further include an identifier of the communication master device 300, and correspondingly, the communication connection request includes a link signature that is generated based on the identifier of the communication master device 300 and the verification information of the second communication channel.

The first communication channel 310 may be set to a single operation mode, and the single operation mode may be a discoverable mode.

The second communication channel 320 may be set to a single operation mode, and the single operation mode may be a passive connection mode.

Corresponding to the information included in the first signal, the communication connection request may be a link signature that is generated based on the verification information of the second communication channel 320, or may be a link signature that is generated based on the identifier of the communication master device 300 and the verification information of the second communication channel 320.

The identifier of the communication master device 300 may include an identifier of the first communication channel of the communication master device.

The identifier of the first communication channel 310 of the communication master device 300 may include a MAC address of the first communication channel 310.

The verification information of the second communication channel 320 of the communication master device 300 may include a MAC address of the second communication channel 320.

The second communication channel 320 may further be used for sending payment information to the communication slave device.

A wireless connection method used between the communication master device 300 and the communication slave device may include at least one of the following: Bluetooth, IrDA, Ultra Wide Band, Zigbee and NFC.

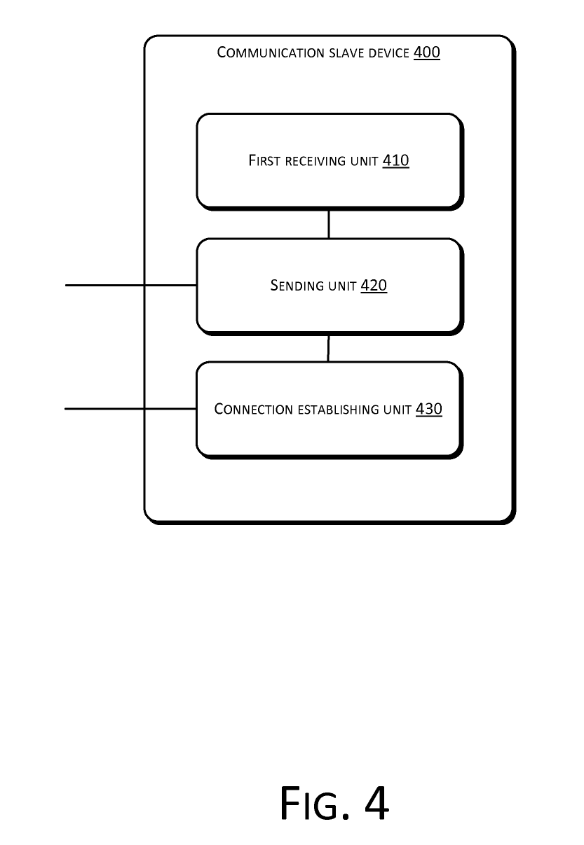

An embodiment of a communication slave device of the present disclosure is described herein. As shown in FIG. 4, the communication slave device 400 includes:

a first receiving unit 410, used for receiving a first signal broadcasted by a communication master device, where the first signal carries verification information of a second communication channel of the communication master device; and receiving a link signature that is returned from a server and generated based on the verification information of the second communication channel of the communication master device;

a sending unit 420, used for sending the verification information of the second communication channel of the communication master device that is received by the first receiving unit to a server; and

a connection establishing unit 430, used for establishing a connection with the communication master device using the returned link signature through the second communication channel of the communication master device.

The first signal may further carry an identifier of the communication master device. The sending unit 420 may further send the identifier of the communication master device to the server. Correspondingly, the link signature returned from the server and received by the first receiving unit 410 may include a link signature that is generated based on the identifier of the communication master device and the verification information of the second communication channel.

Information of the identifier of the communication master device may include an identifier of the first communication channel of the communication master device.

The identifier of the first communication channel of the communication master device may include a MAC address of the first communication channel of the communication master device.

The verification information of the second communication channel of the communication master device may include a MAC address of the second communication channel.

The first receiving unit 410 may further be used for receiving payment information from the communication master device through the second communication channel. The sending unit 420 may further be used for sending the payment information that is received by the first receiving unit 410 from the communication master device through the second communication channel to the server.

A wireless connection method used between the communication master device and the communication slave device 400 may include at least one of the following: Bluetooth, IrDA, Ultra Wide Band, Zigbee and NFC.

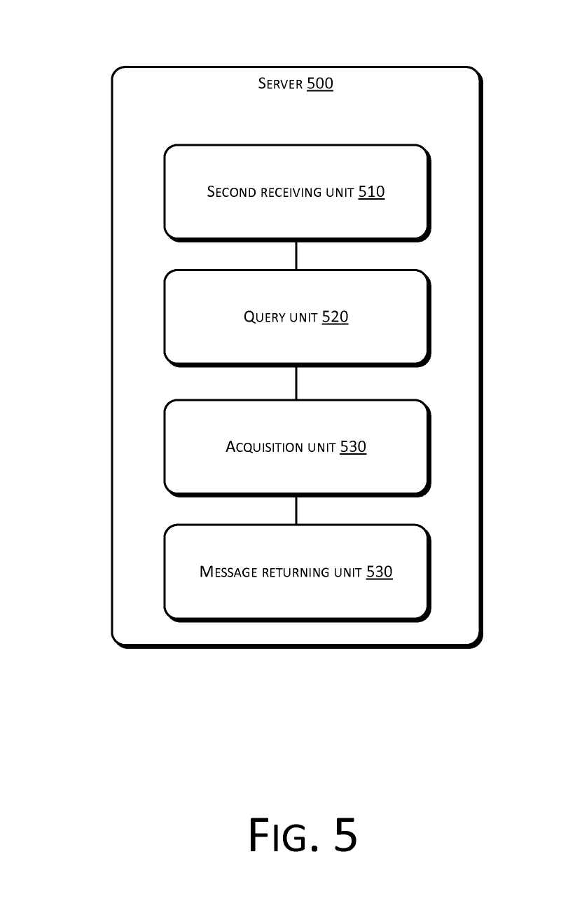

An embodiment of a server of the present disclosure is described herein. As shown in FIG. 5, the server 500 includes:

a second receiving unit 510, used for receiving a message from a communication slave device, where the message includes verification information of a second communication channel of a communication master device;

a query unit 520, used for querying whether the verification information of the second communication channel of the communication master device is valid;

an acquisition unit 530, used for acquiring a link signature of the second communication channel when a query result of the query unit indicates that the verification information is valid; and

a message returning unit 540, used for returning the link signature to the communication slave device.

The message may further include an identifier of the communication master device. Correspondingly, the query unit may further be used for querying whether the identifier of the communication master device is valid, and when the identifier of the communication master device and the verification information of the second communication channel that are queried by the query unit 520 are valid, the acquisition unit 530 may acquire the link signature of the second communication channel.

The identifier of the communication master device may include an identifier of the first communication channel of the communication master device.

The identifier of the first communication channel of the communication master device may include a MAC address of the first communication channel.

The verification information of the second communication channel of the communication master device may include a MAC address of the second communication channel.

The second receiving unit 510 may further be used for receiving payment information that is sent from the communication slave device.

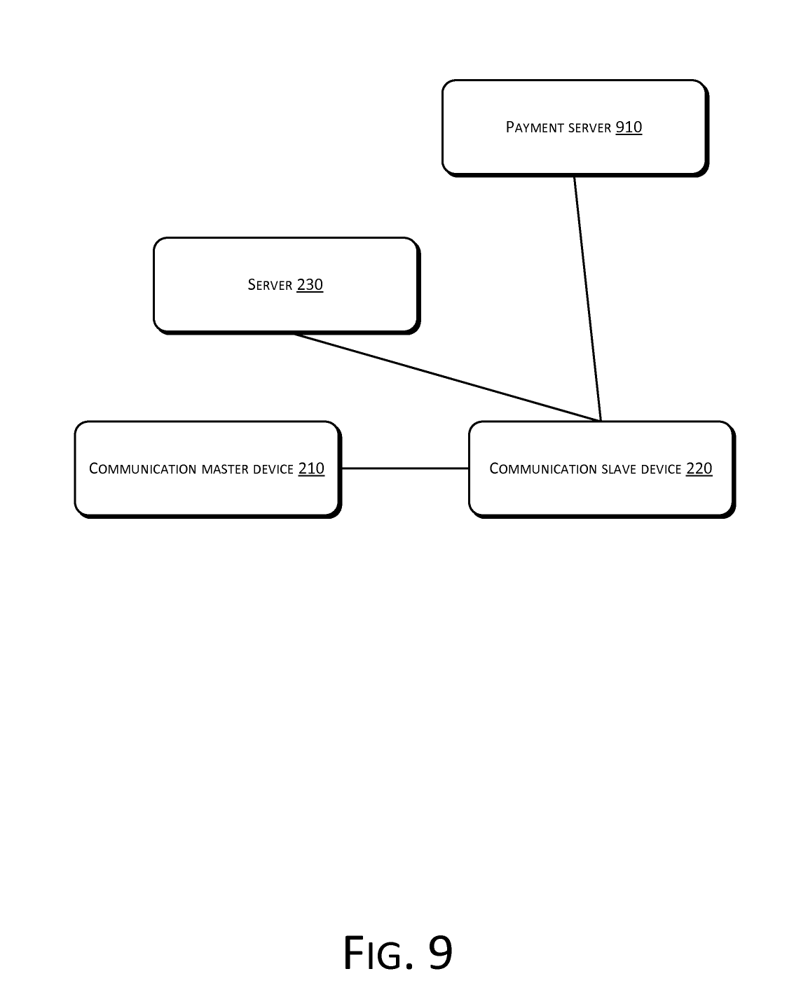

An embodiment of another wireless communications system of the present disclosure is described herein. As shown in FIG. 9, besides the various units in FIG. 2, the wireless communications system further includes:

a payment server 910, used for receiving the payment information that is forwarded by the communication slave device 220 and that includes a payment ID of the communication master device 210, and completing a payment.

Correspondingly, the communication master device 210 further sends the payment information that includes the payment ID of the communication master device 210 to the communication slave device 220.

The system, apparatus, module, or unit illustrated in the foregoing embodiments may be specifically implemented by a computer chip or an entity, or implemented by a product having certain function(s).

For ease of description, the above apparatus is divided into different units based on functions for separate description. In an embodiment, in an implementation of the present disclosure, functions of different units may be implemented in one or more pieces of software and/or hardware.

The embodiments in this specification are each described in a progressive manner. Emphasis of each embodiment is different from those of the other embodiments, and reference may be made to one another for same or similar parts. In particular, the system embodiments are substantially similar to the method embodiments, and therefore are described in a relatively simple manner. References may be made to associated parts of the method embodiments.

In the 1990s, a technological improvement may be differentiated between a hardware improvement (for example, improvement in circuit structures such as a diode, a transistor, a switch, etc.) and a software improvement (improvement in a method/process). However, alone with the development in technologies, improvement in current methods or procedures may be regarded as a direct improvement of hardware circuit structures. Corresponding hardware circuit structures may be acquired by programming improved methods or procedures into hardware circuits. Therefore, one cannot say that improvement in methods and procedures cannot be achieved by hardware modules. For example, a programmable logic device (PLD), such as field programmable gate array (FPGA), is such an integrated circuit, which logic function may be determined by user via device programming. A digital system may be integrated onto a PLD via programming by designers, who do not need to ask chip manufacturers to design and manufacture an application-specific integrated circuit chip 2. Furthermore, manual manufacture of integrated circuit chips may mostly be replaced by using logic compiler software, which is similar to a software compiler used for program development and compilation. Original codes may also be written in a specific programming language before compiling, which is referred to as a hardware description language (HDL). HDL does not have one type only, but includes many types such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language) and the like, with the most commonly used nowadays being VHDL (Very-High-Speed Integrated Circuit Hardware Description Language) and Verilog2. One skilled in the art should understand that hardware circuits for implementing the logic method and procedure may be easily acquired by logically programming the method and procedure into an integrated circuit using the foregoing hardware description languages.

A controller may be realized in any appropriate manner. For example, a controller may use a microprocessor or a processor, and computer readable media for storing computer readable programming codes (such as software or firmware) that are executable by the (micro)processor, a logic gate, a switch, an application specific integrated circuit (ASIC), a programmable logic controller (PLC) or an embedded microcontroller. Examples of a controller include, but are not limited to, the following microcontrollers: ARC 625D, Atmel AT91SAM, Microchip PIC18F26K20 and Silicone Labs C8051F320. A memory controller may also be realized as a part of a control logic of a memory device.

One skilled in the art also knows that, other than realizing the controller by means of pure computer readable programming codes, logic programming may be performed for method blocks to realize the same function of the controller in a form such as a logic gate, a switch, an application specific integrated circuit, a programmable logic controller, and an embedded microcontroller, etc. Therefore, this type of controller may be regarded as a hardware component, and devices included therein for realizing various functions may also be regarded as an internal structure of the hardware component. Even more, devices for realizing various functions may be regarded as software modules for realizing the methods and the internal structure of the hardware component.

From the description of the foregoing implementations, one skilled in the art can clearly understand that the present disclosure can be implemented in software with a necessary general purpose hardware platform. Based on this understanding, the technical solutions of the present disclosure in essence or the part of contribution to the existing technologies may be embodied in a form of a software product. The computer software product may be stored in a storage medium, such as a read-only memory (ROM)/random access memory (RAM), a magnetic disk, or an optical disk, and includes a number of instructions to instruct a computing device (which may be a personal computer, a server, or a network device, etc.) to execute the embodiments of the present disclosure or the methods described in certain parts of the embodiments.

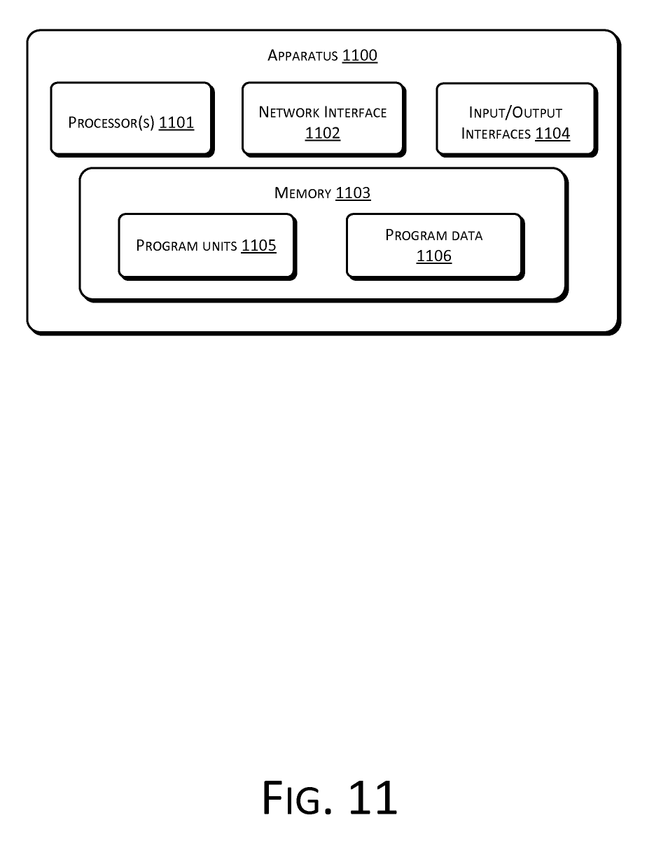

For example, FIG. 11 shows an example apparatus 1100, such as the device or server as described above, in more detail. In an embodiment, the apparatus 1100 may include, but is not limited to, one or more processors 1101, a network interface 1102, memory 1103 and an input/output interface 1104.

The memory 1103 may include a form of computer readable media such as a volatile memory, a random access memory (RAM) and/or a non-volatile memory, for example, a read-only memory (ROM) or a flash RAM. The memory 1103 is an example of a computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 1103 may include program units 1105 and program data 1106. Depending on which system (such as the wireless communications system 100 or 200, etc.), device (e.g., the communication master device 300, the communication slave device 400, etc.) or server (such as the server 500, the payment server 910, etc.) that the apparatus 1100 corresponds to, the program units 1105 may include one or more units as described in the foregoing embodiments. Details of these units may be found in the foregoing description and are therefore not redundantly described herein.

The present disclosure may be used in environments or configurations of various general purpose or application-specific computer systems, for example, a personal computer, a server computer, a handheld device or a portable device, a tablet device, a multi-processor system, a microprocessor-based system, a set-top box, a programmable consumer electronic device, a network PC, a small-scale computer, a large-scale computer, and a distributed computing environment including any of the foregoing systems or devices.

The present disclosure may be described in the context of computer executable instructions, for example, program modules, that are executable by a computer. Generally, a program module comprises a routine, a procedure, an object, a component, a data structure, etc., that executes a specific task or implements a specific abstract data type. The present disclosure may also be put into practice in a distributed computing environment. In such distributed computing environment, a task is performed by a remote processing apparatus that is connected via a communications network. In a distributed computing environment, program modules may be positioned in local and remote computer storage media including storage devices.

Although the present disclosure is described with reference to the embodiments, one of ordinary skill in the art understand that the present disclosure has a number of variations and modifications without departing from the spirit of the present disclosure, and the appended claims are expected to include these variations and modifications without departing from the spirit of the present disclosure.

1. A method of establishing a wireless communication connection, comprising:
broadcasting a first signal via a first communication channel of a communication master device, the first signal including verification information of a second communication channel of the communication master device;
receiving, via the second communication channel, a communication connection request generated by a communication slave device based on the first signal; and
establishing a data communication connection with the communication slave device in the second communication channel according to the communication connection request.

2. The method of claim 1, wherein the first communication channel of the communication master device is set to a single operation mode, and the single operation mode is a discoverable mode.

3. The method of claim 1, wherein the second communication channel of the communication master device is set to a single operation mode, and the single operation mode is a passive connection mode.

4. The method of claim 1, wherein the communication connection request comprises a link signature that is generated based on the verification information of the second communication channel of the communication master device.

5. The method of claim 1, wherein the first signal further includes an identifier of the communication master device, and correspondingly, the communication connection request includes a link signature that is generated based on the identifier of the communication master device and the verification information of the second communication channel.

6. The method of claim 5, wherein the identifier of the communication master device comprises an identifier of the first communication channel of the communication master device.

7. The method of claim 6, wherein the identifier of the first communication channel of the communication master device comprises a Media Access Control address of the first communication channel.

8. The method of claim 1, wherein the verification information of the second communication channel of the communication master device comprises a Media Access Control address of the second communication channel.

9. The method of claim 1, wherein the method further comprises sending, by the communication master device, payment information to the communication slave device through the second communication channel.

10. The method of claim 1, wherein the communication connection comprises a connection in at least one of Bluetooth, infrared, Ultra Wide Band, Zigbee or Near Field Communication.

11. One or more computer-readable media storing executable instructions that, when executed by one or more processors, cause the one or more processors to perform acts comprising:
receiving a first signal broadcasted by a first communication channel of a communication master device, the first signal including verification information of a second communication channel of the communication master device;
parsing the first signal and acquiring the verification information of the second communication channel of the communication master device;
sending the verification information of the second communication channel of the communication master device to a server;
receiving a link signature that is returned by the server and that is generated based on the verification information of the second communication channel of the communication master device; and
requesting to establish a communication connection with the second communication channel of the communication master device based on the link signature.

12. The one or more computer-readable media of claim 11, wherein the first signal further includes an identifier of the communication master device, and the acts further comprise:
parsing the first signal to acquire the identifier of the communication master device;
sending the identifier of the communication master device to the server, wherein the link signature that is returned from the server comprises a link signature that is generated based on the identifier of the communication master device and the verification information of the second communication channel.

13. The one or more computer-readable media of claim 12, wherein the identifier information of the communication master device comprises an identifier of the first communication channel of the communication master device.

14. The one or more computer-readable media of claim 13, wherein the identifier of the first communication channel of the communication master device comprises a Media Access Control address of the first communication channel of the communication master device.

15. The one or more computer-readable media of claim 11, wherein the verification information of the second communication channel of the communication master device comprises a Media Access Control address of the second communication channel.

16. The one or more computer-readable media of claim 11, the acts further comprising a communication slave device receiving payment information sent from the communication master device through the second communication channel, and forwarding the payment information to a payment server.

17. A server comprising:
one or more processors;
memory storing executable instructions that, when executed by the one or more processors, cause the one or more processors to perform acts comprising:
receiving a message that is sent from a communication slave device, the message including verification information of a second communication channel of a communication master device;
querying whether the verification information of the second communication channel of the communication master device is valid, and acquiring a link signature of the second communication channel in response to determining that the verification information of the second communication channel of the communication master device is valid; and
returning the link signature to the communication slave device.

18. The server of claim 17, wherein the message that is sent from the communication slave device further comprises an identifier of the communication master device, and the acts further comprise:
querying whether the identifier of the communication master device is valid; and
acquiring the link signature of the second communication channel in response to determining that the identifier of the communication master device and the verification information of the second communication channel are valid.

19. The server of claim 17, wherein the verification information of the second communication channel of the communication master device comprises a Media Access Control address of the second communication channel.

20. The server of claim 17, the acts further comprising receiving payment information from the communication slave device.
